(19) United States
(12) Patent Application Publication
(10) Pub. No.: US 2026/0274004 A1
(43) Pub. Date: Sep. 17, 2026

(54) Hydroplane Prevention System

(71) Applicant: Clint Clark, San Jose, CA (US)

(72) Inventor: Clint Clark, San Jose, CA (US)

(21) Appl. No.: 19/080,860

(22) Filed: Mar. 16, 2025

(51) Int. Cl. B60B 39/02

(52) U.S. Cl. CPC B60B 39/025; B60B 39/026

(57) ABSTRACT

Hydroplaning Prevention System Utilizing Directed Air Pressure The present invention relates to a hydroplaning prevention system employing an actively maintained, directed pressurized airflow barrier positioned ahead of vehicle tires. The continuous, dynamically controlled airflow barrier proactively prevents water from accumulating beneath the tires, thereby maintaining optimal tire-road contact and significantly improving vehicle safety, stability, and traction under wet conditions.

### BACKGROUND OF THE INVENTION

### Problem Statement

Hydroplaning represents a significant safety hazard in vehicle operation, occurring when tires lose direct contact with the road surface due to the presence of a water layer beneath the tires. This condition drastically reduces tire traction, impairs driver control, and severely compromises vehicle responsiveness, substantially elevating the risk of accidents.

### Limitations of Existing Solutions

Conventional tire tread patterns offer only limited and passive water displacement capabilities, becoming ineffective under heavy rainfall or high-speed conditions.
Road surface drainage systems are highly dependent on infrastructure maintenance and fail to provide a tailored, vehicle-specific solution capable of adapting dynamically to immediate driving scenarios.
Electronic Stability Control (ESC) and other traction management systems are reactive measures, typically intervening only after hydroplaning conditions or loss of traction has already occurred, rather than proactively preventing the event.

### SUMMARY OF THE INVENTION

The present invention relates to an advanced hydroplaning prevention system that proactively employs directed pressurized airflow to actively displace water ahead of vehicle tires, maintaining continuous tire-road contact and significantly enhancing vehicle safety and stability in wet driving conditions.

### BRIEF DESCRIPTION OF THE DRAWINGS

FIG. 1: Illustrates the system setup with the nozzle housed within the wheel well cover, supplied with high-pressure air from an air compressor powered by the vehicle battery.

FIG. 2: Shows an alternative system configuration utilizing a high-powered mini air blower motor positioned within the wheel well cover to supply pressurized air to the nozzle.

FIG. 3: Depicts the system utilizing air pressure from the vehicle's air suspension system.

FIG. 4: Demonstrates the nozzle positioned on the splash guard with a protective housing unit to reduce counter pressure from external factors.

FIG. 5: Shows a nozzle within a housing unit fitted onto the wheel well cover, supplied by an air compressor powered by an electric battery.

FIG. 6: Illustrates the directed stream of air pressure, the contact point on the road surface, and the formation of the airflow barrier against the tire.

FIG. 7: Depicts the directed stream of air pressure forming a continuous barrier preventing water intrusion beneath the tire.

### DETAILED DESCRIPTION OF THE INVENTION

### 1. System Components

a) Air Pressure Generation Unit

The air pressure generation unit includes components capable of instantaneous activation and sustained airflow delivery, ensuring continuous and adaptable operation:
A high-output air compressor engineered for sustained, adjustable airflow output.
A high-powered electric blower motor driven by the vehicle's electrical system.
A pre-pressurized air reservoir for immediate and rapid airflow activation.
Integration capabilities with the vehicle's existing air suspension or tire inflation systems.
Optional heated airflow delivery for effectiveness under colder climate conditions.

### b) Directional Nozzles and Airflow Control

Directional nozzles are specifically engineered and strategically placed to form and actively maintain a continuous, impenetrable airflow barrier:
Mounted ahead of the vehicle's tires in optimized locations such as wheel wells, splash guards, and bumpers.
Angled downward and towards the tire, directing high-pressure airflow onto the roadway ahead of each tire.
Engineered to ensure sufficient airflow pressure and volume to prevent water penetration beneath the tire-road interface.
Equipped with dynamically adjustable mounts for real-time adaptation to changing driving conditions.

### FIGURES

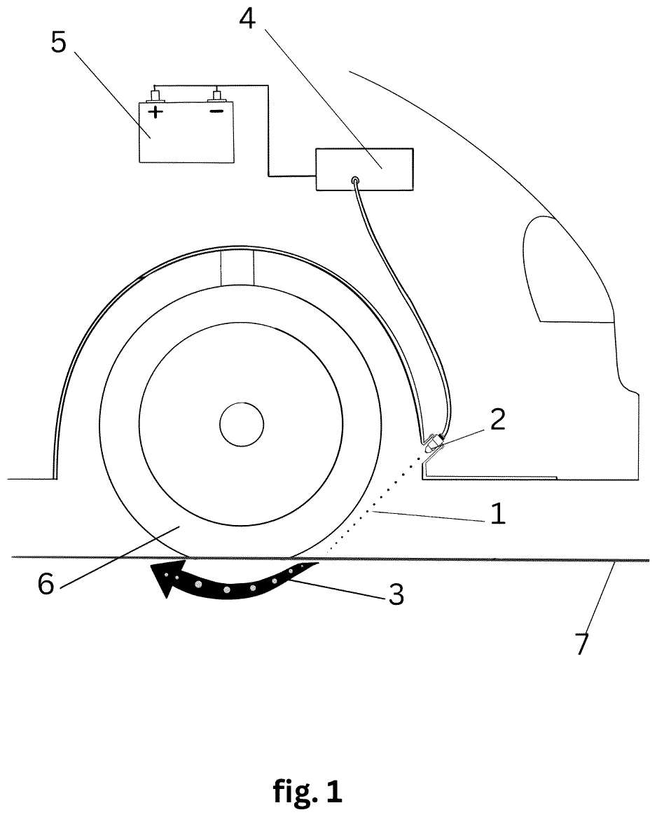

FIG. 1: System setup with nozzle housed within wheel well cover.

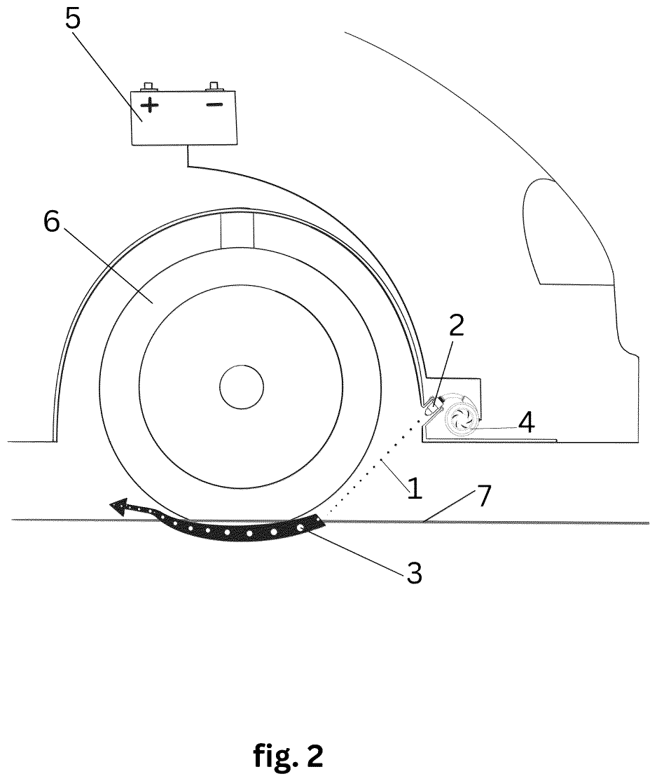

FIG. 2: Alternative system with a high-powered mini air blower motor.

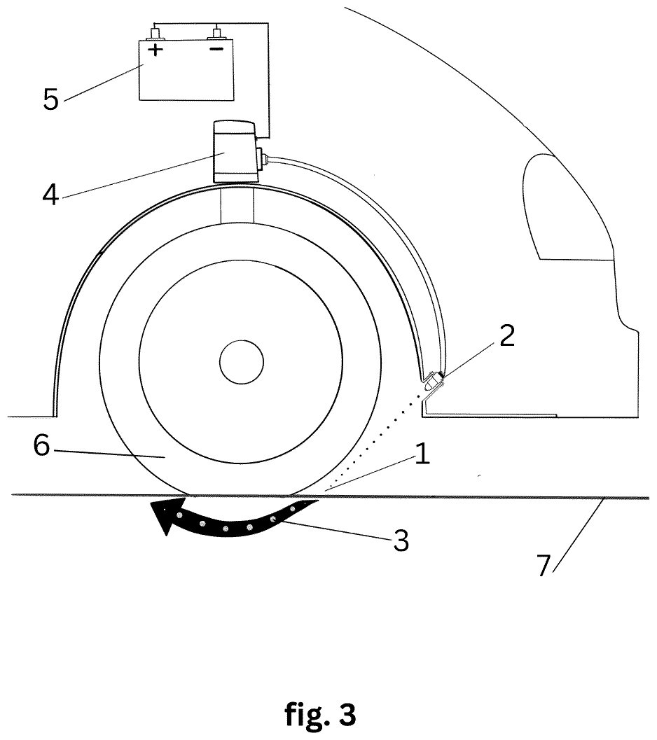

FIG. 3: System utilizing air pressure from vehicle's air suspension.

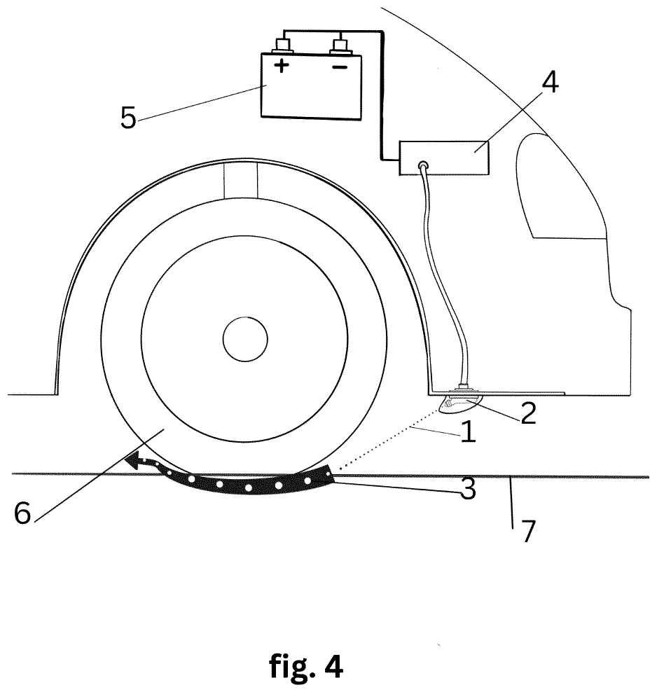

FIG. 4: Nozzle positioned on the splash guard with protective housing.

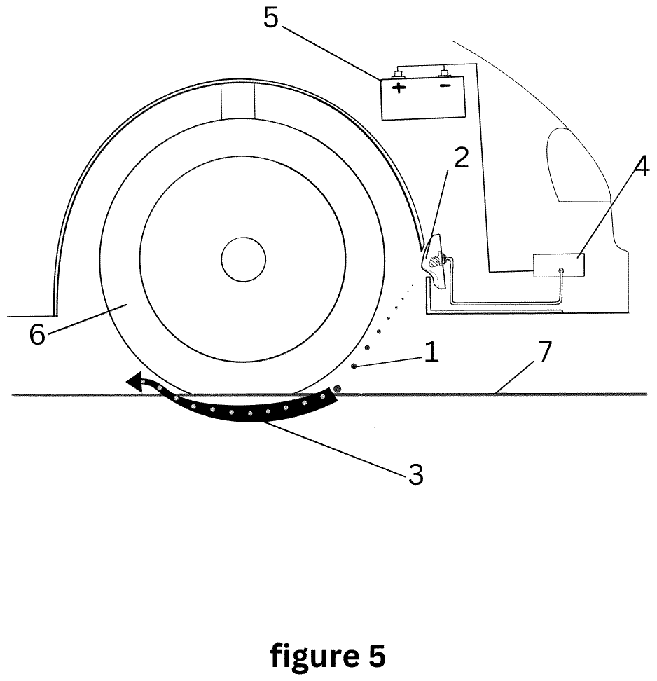

FIG. 5: Nozzle fitted onto the wheel well cover, supplied by an air compressor.

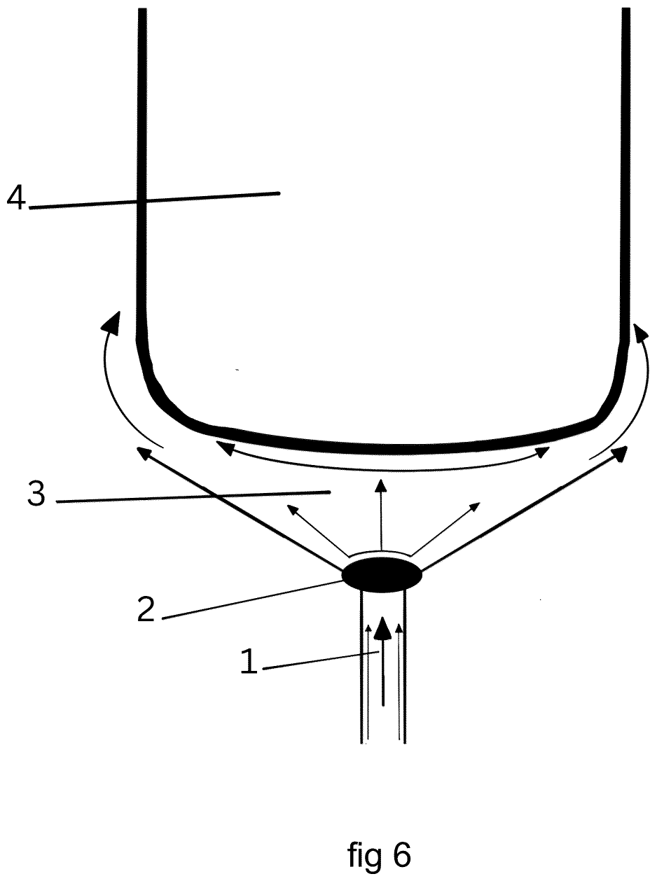

FIG. 6: Directed stream of air pressure forming the airflow barrier.

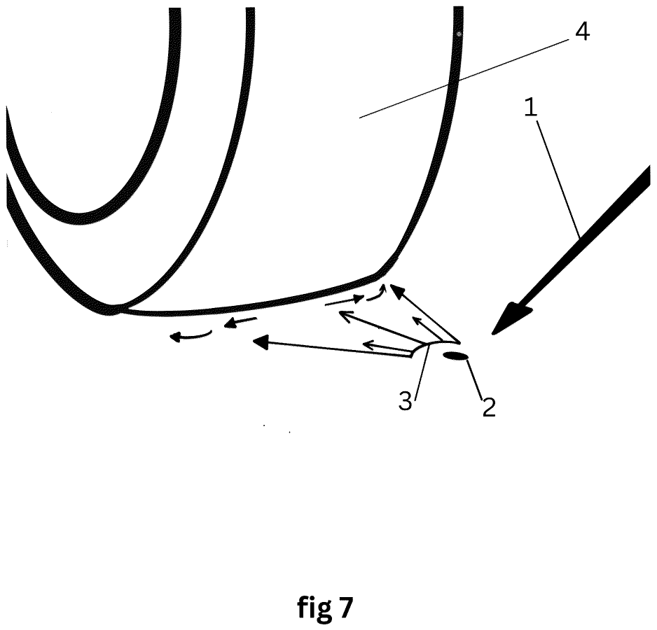

FIG. 7: Airflow barrier preventing water intrusion beneath the tire.

What is claimed is:

1. A hydroplaning prevention system for a vehicle, comprising:
a) One or more directional nozzles positioned ahead of the vehicle's tires, configured to direct a high-pressure stream of air onto the road surface to form and maintain an active airflow barrier;
b) A pressurized air source supplying the directional nozzles with continuous, adjustable airflow;
c) A dynamically controlled airflow barrier preventing water accumulation beneath the tires;
d) An advanced sensor-based control system for autonomous activation and real-time airflow modulation.

2. The hydroplaning prevention system of claim 1, wherein the pressurized air source includes a high-powered electric blower motor.

3. The hydroplaning prevention system of claim 1, wherein the system integrates with the vehicle's air suspension system.

4. The hydroplaning prevention system of claim 1, wherein environmental sensors detect wet conditions and activate the airflow barrier.

5. The hydroplaning prevention system of claim 1, wherein the directional nozzles include adjustable mounts for optimizing airflow angles.

6. The hydroplaning prevention system of claim 1, wherein the airflow barrier's pressure adjusts dynamically based on vehicle speed.

7. The hydroplaning prevention system of claim 1, wherein the system integrates with vehicle safety systems including ABS and ESC.

8. The hydroplaning prevention system of claim 1, further comprising integration capability with autonomous driving technologies.

9. The hydroplaning prevention system of claim 1, wherein the system can be installed as an aftermarket retrofit kit.
